(19) United States
(12) Patent Application Publication
(10) Pub. No.: US 2024/0094043 A1
(43) Pub. Date: Mar. 21, 2024

(54) WEIGHING ASSEMBLY FOR A PACKAGE HANDLING SYSTEM

(71) Applicant: Espera-Werke GmbH, Duisburg (DE)

(72) Inventor: Marc SCHRIEFERS, Viersen (DE)

(21) Appl. No.: 18/274,396

(22) PCT Filed: Feb. 16, 2022
(86) PCT No.: PCT/EP2022/053814

§ 371 Date: Jul. 26, 2023

(30) Foreign Application Priority Data
Feb. 17, 2021 (DE) 10 2021 103 725.5

(51) Int. Cl. G01G 19/03; B65C 1/02; B65C 9/46; G01G 19/52; G01G 23/36

(52) U.S. Cl. CPC G01G 19/03; B65C 1/021; B65C 9/46; G01G 19/52; G01G 23/36

(57) ABSTRACT

The invention relates to a weighing assembly (1) for a package handling system (2) for handling individual packages (3), wherein the weighing assembly has: —a sensor unit (4) for acquiring sensor data related to the weight of the individual packages (3), and—an analysis unit (5), wherein system information containing weighing parameters and calibration information related to the weighing parameters is stored in the analysis unit (5), wherein the analysis unit (5) determines weight values for the individual packages (3) from the sensor data on the basis of the weighing parameters, and wherein the analysis unit (5) is designed to transmit the weight values to a control assembly (9) via a data interface (8) of the weighing assembly. According to the invention, a display selection which defines at least part of the system information as information to be displayed is stored in the analysis unit (5), and the analysis unit (5) is designed to prompt the display of the information to be displayed via a visual display device (12) which is independent of the control assembly (9).

### CROSS-REFERENCE TO RELATED APPLICATIONS

This application is a U.S. national stage of International Application Number PCT/EP2022/053814, filed Feb. 16, 2022, and claims priority to DE 10 2021 103 725.5, filed Feb. 17, 2021.

### BACKGROUND OF INVENTION

The invention relates to a weighing arrangement for a package-handling system, to a package-handling system, and also to a method for operating a package-handling system.

The package-handling systems in question are employed, in particular, in food processing and food production. In particular, transporting, filling, imprinting and/or labeling of the packages can be undertaken with the handling of the packages. In particular for weight-dependent price-tagging or for inspection weighing of the individual packages, a weighing arrangement is employed that, preferentially in the case of a continuous feed arrangement for the packages, generates weight values of the respective package. The weight values are then drawn upon for the imprinting of the package and/or for the printing of a label to be applied. Packages already provided with a weight tagging in advance, for instance, are processed by inspection weighing, whereby an actual weight value of the package is compared with a target weight value that is representative of the overprinted weight value.

The operation of the package-handling system necessitates a simultaneous, mutually coordinated triggering of individual functional units of the package-handling system. With the advancing development of the networking of electronic components, new possibilities for triggering the package-handling system are opening up, whereby the functional units can communicate with one another and be controlled via networks. Therefore a subdivision of the control-engineering tasks between local, decentralized control components and centralized control components can also be undertaken.

Networked systems also result in greater flexibility for the user. In this connection, it is conceivable that the user no longer has to remain at all times in the immediate vicinity of functional units of the package-handling system but rather undertakes the necessary inputs and outputs via a mobile device or via a remote computer, whereby, for instance, several functional units can also be taken care of in parallel by one user.

The problem underlying the invention is to provide a weighing arrangement for a package-handling system, said weighing arrangement enabling a flexible operation of the package-handling system.

### BRIEF SUMMARY OF THE INVENTION

In the case of a weighing arrangement for a package-handling system for handling individual packages, preferentially food packages, the weighing arrangement exhibiting a sensor unit, for ascertaining sensor data relating to the weight of the individual packages, and also an evaluation unit, wherein system information that contains weighing parameters and also calibration information relating to the weighing parameters has been stored in the evaluation unit, wherein the evaluation unit determines weight values for the individual packages from the sensor data by reference to the weighing parameters, and wherein the evaluation unit has been set up to communicate the weight values to a control arrangement of the package-handling system via a data interface of the weighing arrangement, the above problem is solved by in that a display selection that defines at least some of the system information as information to be displayed has been stored in the evaluation unit, and in that the evaluation unit has been set up to bring about the display of the information to be displayed via a visual display device that is independent of the control arrangement.

The weighing arrangement exhibits a sensor unit, for ascertaining sensor data relating to the weight of the individual packages, and also an evaluation unit, system information that contains weighing parameters as well as calibration information relating to the weighing parameters having been stored in the evaluation unit. The evaluation unit determines weight values for the individual packages from the sensor data by reference to the weighing parameters, the evaluation unit having been set up to communicate the weight values to a control arrangement of the package-handling system via a data interface of the weighing arrangement.

Essential is the fundamental consideration that a local user interface provided near the package-handling system, such as a centralized operating-and-display panel, is actually dispensable, since the user may also have recourse to mobile devices or remote computers in order to operate the package-handling system. However, the visual display of certain information in the course of the operation of the package-handling system is imperative, in order to continue to enable local operation or monitoring of the package-handling system by a user, and in order to comply with statutory requirements.

In detail, it is proposed that a display selection that defines at least some of the system information as information to be displayed has been stored in the evaluation unit, and that the evaluation unit has been set up to bring about the display of the information to be displayed via a visual display device that is independent of the control arrangement.

In accordance with the proposal, with the display selection it is furthermore guaranteed that the information to be displayed that is imperative for operation is displayed via a visual display device provided for this purpose. The weighing arrangement can therefore be operated independently of the way in which the user undertakes an input and output of data in respect of the package-handling system, in which connection, in particular, a user interface provided locally near the package-handling system may be dispensed with. The visual display device that is provided for the information to be displayed pertaining to the weighing arrangement may be of substantially simpler and more cost-effective construction in comparison with a centralized operating-and-display panel of the package-handling system.

In one embodiment, weight values of the individual packages can be displayed, in order to permit a simple monitoring of the weighing arrangement.

If at least one part of the display selection has been permanently specified, the display of information that is required at all times can be ensured. With a preselection of the display selection depending on the package-handling system, in particular depending on the location of the package-handling system, the respective regional requirements as regards the display of the information can be taken into account.

Configurations of the weighing arrangement with basic price values assigned to the product-type of the individual packages are also disclosed, with which the package-handling system is utilized, in particular, as a price-tagging device.

Particularly advantageous, in addition, are the configurations wherein the evaluation unit undertakes a check as to whether a display of the information to be displayed by the visual display device is occurring. This configuration of the weighing arrangement consequently guarantees, with a high degree of certainty, that the visual display device which has been formed separately, in particular from the weighing arrangement, is operational and the display is actually taking place.

According to a further teaching, to which independent significance is attached, the package-handling system is claimed as such. The package-handling system exhibits a weighing arrangement according to the proposal and also a visual display device for the information to be displayed, output by the evaluation unit. Reference may be made to all the remarks with respect to the weighing arrangement according to the proposal.

In the preferred configuration, the package-handling system exhibits a labeling device, in which connection the weight values ascertained by the weighing arrangement can be taken into consideration when the label is being printed.

According to a further teaching, to which independent significance is likewise attached, a method for operating a package-handling system is claimed as such. Also in this respect, reference may be made to all the remarks with respect to the weighing arrangement according to the proposal and with respect to the package-handling system according to the proposal.

### BRIEF DESCRIPTION OF THE DRAWINGS

In the following, the invention will be elucidated in more detail by reference to a drawing representing merely an embodiment. In the drawing,

FIG. 1 shows a schematic representation of the package-handling system according to the proposal with a weighing arrangement according to the proposal for carrying out the method according to the proposal.

### DETAILED DESCRIPTION OF THE INVENTION

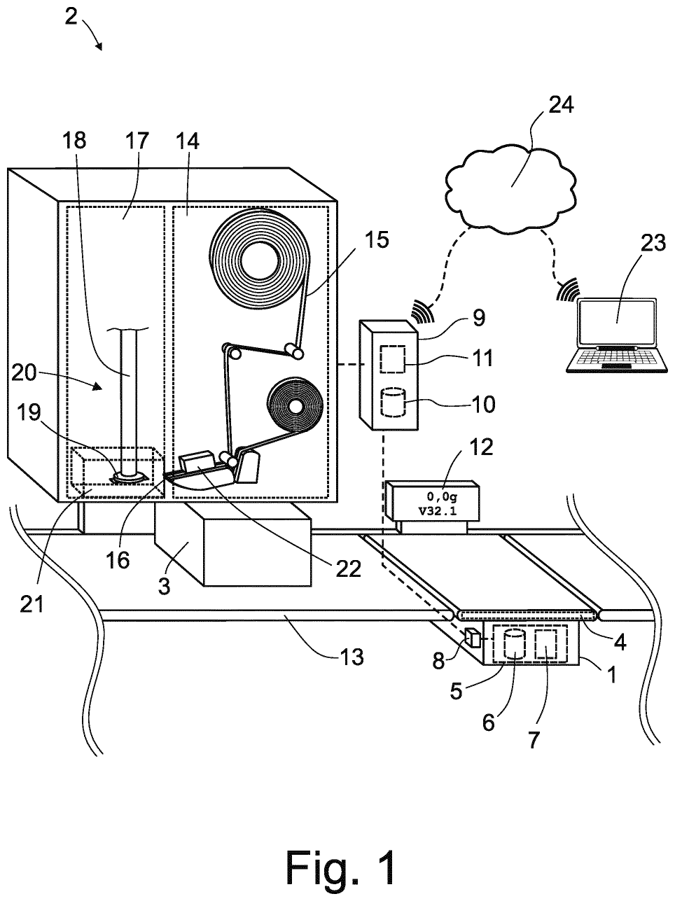

The invention relates to a weighing arrangement 1 for a package-handling system 2 for handling individual packages 3, preferentially food packages. FIG. 1 here shows, in a schematic representation, the package-handling system 2 with a labeling device which in a preferred configuration has been configured as a price-tagging device, in which connection the weighing arrangement 1 according to the proposal will firstly be considered.

The weighing arrangement 1 exhibits a sensor unit 4 for ascertaining sensor data relating to the weight of the individual packages 3. The weighing arrangement 1 has preferentially been configured as a dynamic weighing arrangement. The sensor unit 4 here has been set up to ascertain the sensor data during the movement of the packages 3 through the package-handling system 2 and therefore in continuous operation of the package-handling system 2. In this connection, the weighing arrangement 1 may exhibit a feed arrangement for transporting respective packages 3, such as a belt conveyor, roller conveyor, robotic arm or such like, and/or may have been assigned to a feed arrangement of the package-handling system 2.

The sensor unit 4 has preferentially been configured as a load cell which ascertains analog and/or digital sensor data that are representative of the weight. The ascertainment of the weight-related sensor data is undertaken, in particular, on the basis of a measurement of the deformation of a support for the packages 3, for instance via strain gauges, and/or on the basis of an electromagnetic compensation of the weight force of the respective package 3.

The weighing arrangement 1 exhibits an evaluation unit 5 which here, and preferentially, is equipped with a memory 6 and with a processor 7. In the memory 6, program instructions of software for the evaluation unit 5 have been stored, the memory 6 and the program instructions having been set up to trigger the weighing arrangement 1 together with the processor 7. System information has been stored in the evaluation unit 5—here, in the memory 6. The system information is generally data relating to the weighing arrangement 1 and to the components thereof, in particular also data from a working memory of the memory 6, which is employed in connection with the evaluation of the sensor data.

The system information contains weighing parameters and also calibration information relating to the weighing parameters. The weighing parameters arise, in particular, from a calibration of the weighing arrangement 1, whereby the evaluation unit 5 determines weight values for the individual packages 3 from the sensor data by reference to the weighing parameters. In particular, the weight values represent a function of sensor values contained in the sensor data, the function having been defined by the weighing parameters. For instance, with the sensor unit 4 an electrical resistance in respect of a strain gauge is ascertained, from which the weight value can be calculated via the weighing parameters.

The evaluation unit 5 has been set up to communicate the weight values to a control arrangement 9 of the package-handling system 2 via a data interface 8 of the weighing arrangement 1. In this connection, the control arrangement 9 has been formed separately from the weighing arrangement 1 and takes over control-engineering tasks of at least one functional unit of the package-handling system 2. Here, and preferentially, the control arrangement 9 exhibits a memory 10 and a processor 11, program instructions having been stored in the memory 10, and the memory 10 and the program instructions having been set up to trigger the package-handling system 2 together with the processor 11. Here, the control arrangement 9 triggers the labeling device for the purpose of carrying out a labeling routine. In the labeling routine, the individual packages 3 are labeled.

The control arrangement 9 undertakes the triggering in a manner depending on the weight values communicated from the evaluation unit 5. The data interface 8 of the weighing arrangement 1 has been set up here for a wired communication of the weight values to the control arrangement 9, a wireless communication of the weight values also being conceivable. The control arrangement 9 may further serve to store and/or to manage product information relating to the respective packages 3.

Now it is essential that a display selection that defines at least some of the system information as information to be displayed has been stored in the evaluation unit 5, and that the evaluation unit 5 has been set up to bring about the display of the information to be displayed via a visual display device 12 that is independent of the control arrangement 9.

The display selection has, in particular, been stored in the memory 6 already mentioned. The system information that, according to the display selection, is considered to be information to be displayed is visualized appropriately via the visual display device 12 at the instigation of the evaluation unit 5. By “a configuration of the visual display device 12 that is independent of the control arrangement 9”, it is meant that the display device 12 does not receive any direct information from the control arrangement 9 for the purpose of visualization. In particular, a communications link between the control arrangement 9 and the display device 12, if present, proceeds at all times via the weighing arrangement 1. Consequently the display device 12 is preferentially a separate display device—more preferentially, provided specifically for the weighing arrangement 1—which serves to reproduce at least some of the system information of the weighing arrangement 1. The display device 12 may have been configured to be separate from the weighing arrangement 1 but arranged locally near the package-handling system 2. The weighing arrangement 1 preferentially exhibits the visual display device 12.

In principle, the instigating of the display of the information to be displayed may occur automatically. For instance, a permanent display or a time-controlled display—for instance, at regular time-intervals—has been provided during the operation of the weighing arrangement 1. Particularly preferably, the evaluation unit 5 brings about the display in response to a user action, for instance in response to an actuation in respect of an operating panel provided for this purpose near the package-handling system 2 and/or near the weighing arrangement 1.

It is preferred, in addition, that the display selection defines at least some of the weight values—preferentially net weight, gross weight, tare, and/or a weight range assigned to the weight—as information to be displayed. The tare may be a weighed tare, which is ascertained separately, or a preset tare—here, a specified value for the tare. For the weight range, a compilation of several weight ranges may have been specified by the user and/or by the manufacturer of the weighing arrangement 1, for instance with specified weight intervals. The weighing parameters are preferentially dependent on the weight range, respective weighing parameters having been stored in the evaluation unit 5, for instance for each weight range.

At least one part of the display selection may have been permanently specified. By “permanently specified”, it is meant that the weighing arrangement 1 does not give the user an option—for instance, by means of a user input—to alter at least the part of the display selection in question. It is consequently ensured that an essential part of the display selection is not influenced inadvertently.

At least one part of the display selection may have been preselected in a manner depending on the package-handling system 2 for which the weighing arrangement 1 has been provided, for instance depending on the respective type of the package-handling system 2—here, of the labeling device—and/or of the other functional units of the package-handling system 2. Particularly preferred is a preselection depending on the respective location of the package-handling system 2, the display selection satisfying, for instance, the regional and/or national minimum requirements, assigned to the location, as regards visualization. By the “location”, in particular the place of deployment of at least one functional unit of the package-handling system 2 is understood. The preselection that is dependent on the package-handling system 2 has preferentially been permanently specified.

According to a particularly preferred configuration, a basic price value assigned to the product-type of the individual packages 3 has been specified to the evaluation unit 5. In this connection, there may be provision that the basic price value is selected by the user from a specified compilation of basic price values by reference to the product-type, and/or that the user establishes the basic price value via a direct input of the numerical value. The basic price value may have been stored in the control arrangement 9. The control arrangement 9 and/or the evaluation unit 5 determine(s) prices of the individual packages 3 preferentially from the sensor data, in particular from the weight values, by reference to the basic price value. The evaluation unit 5 can output the prices via the data interface 8 of the weighing arrangement 1, preferentially to the control arrangement 9. Here, and preferentially, the prices are taken into consideration by the control arrangement 9 when the labels are being printed, for instance with an individual price-tagging of the packages 3 via the printing of the labels.

In this connection, it is particularly preferred that the display selection defines the prices, the basic price and/or the product-type as information to be displayed, so that these data that are relevant for the price-tagging are visualized on the visual display device 12.

According to a further, likewise preferred, configuration, the display selection defines as information to be displayed a digital type-plate stored in the evaluation unit 5, which relates to at least one of minimally permissible weight, maximally permissible weight, weight-division values, weighing-instrument class, manufacturer, serial number and/or electrical operating-voltage values. In the case of the weight-division values, it is a question of the smallest difference in respect of the weight that is still taken into consideration in the weight values. The weighing-instrument class may be undertaken on the basis of a selection from a specified compilation of weighing-instrument classes, preferentially in accordance with a standard, more preferentially in accordance with Directive 2014/31/EU and/or 2014/32/EU, according to which weighing arrangements are classified as, for instance, coarse weighing instruments (class IIII), commercial weighing instruments (class III), precision weighing instruments (class II) and fine weighing instruments (class I). Specific requirements as regards calibration may have been assigned to each class of weighing instrument.

In principle, the display of the information to be displayed can be brought about in a temporal sequence. For instance, information for the digital type-plate is shown in succession, in particular on the same display panel of the visual display device 12 (minimally permissible weight->maximally permissible weight->weight-division values->minimally permissible weight->etc.). As already mentioned, the temporal sequence of the display can also be brought about in response to a user action.

According to a further, likewise preferred, configuration, the calibration information is representative of a versioning—preferentially a software version—of the evaluation unit 5, and/or of the calibration period. It is conceivable, in addition, that the calibration information is representative of a deactivated state of the weighing arrangement 1, in which connection, in the case where the calibration of the weighing arrangement 1 has expired, the package-handling system 2 can, for instance, continue to be operated even without the weighing arrangement 1. In this case, the display device 12 signals the deactivated state of the weighing arrangement 1.

Particularly preferably, the evaluation unit 5 has been set up to bring about the display of the information to be displayed via the visual display device 12 in compliance with a specified period of time. In this connection, a specified minimum display duration and/or maximum display duration is preferentially adhered to, so that a sufficient visualization of the information to be displayed is ensured, even in ongoing operation. The minimum display duration and/or maximum display duration may be relative, in particular, to the time of ascertainment of the sensor data, so that the package 3 to which the information displayed on the display device 12 is to be assigned is made clear to the user in straightforward manner.

According to a particularly preferred configuration, the evaluation unit 5 undertakes a check as to whether a display of the information to be displayed by the visual display device 12 can occur. In general, the evaluation unit 5 checks the compliance with at least one check criterion that is indicative of the fact that a display can occur—for instance, via a request via the user—or that an automatically triggered display is actually occurring.

Particular preferably, the checking of the connection of the weighing arrangement 1 relates to the visual display device 12. For instance, in the case of a wired connection a resistance measurement and/or a capacitance measurement of the connecting lead may be taken, in order to check the integrity thereof. Correspondingly, a check criterion may have been defined by the condition that the resistance value and/or the capacitance value of the connecting lead comply/complies with a specified minimum value and/or maximum value. In the case of a wireless connection, a check can be made, for instance, via a ping test or such like.

Likewise, an inseparable connection of the weighing arrangement 1 to the visual display device 12 may have been provided, in which case the check may, in particular, then also be dispensed with. By “inseparable” here, it is meant that the connection cannot be separated non-destructively—for instance, not without severing a connecting cable.

The check preferably relates to the operating state of the visual display device 12. For instance, the display device 12 of the weighing device 1 can communicate operating-state information, such as whether the display device 12 has been switched on, whether there is an electrical power supply for the display device 12, or such like. It is likewise preferred if a feedback from the display device 12 has been provided which, for instance, is generated by the display device 12 and communicated to the weighing arrangement 1 only when the display has already occurred or is at least available to the user. The display device 12 can consequently acknowledge the possible display of the information to be displayed. A check criterion may have been defined by the condition that the feedback from the display device 12 of the weighing arrangement 1 is present.

In this connection, it is particularly preferred if the evaluation unit 5 has been set up to communicate the weight values to the control arrangement 9 of the labeling device 2 only when, according to the check, an output of the information to be displayed by the visual display device 12 can occur. But if the check shows that it is unlikely that a display can occur—for instance, by reason of a lack of a connection between the weighing arrangement 1 and the display device 12, or by reason of a deactivated display device 12—the evaluation unit 5 also does not communicate any weight values. In particular, also no communication of any other information concerning packages 3 from the weighing arrangement 1 to the control arrangement 9 occurs. It is conceivable that merely the output of error information from the weighing arrangement 1 to the control arrangement 9 occurs. Consequently, the weighing arrangement 1 can preferentially be utilized in handling only when the display of the information to be displayed has been ensured with sufficient probability.

According to a further teaching, to which independent significance is attached, the aforementioned package-handling system 2, with a feed arrangement 13 for transporting respective packages 3, the package-handling system 2 exhibiting a control arrangement 9 for triggering the feed arrangement 13, is claimed as such.

In the case of the package-handling system 2, it is essential that the package-handling system 2 exhibits a weighing arrangement 1 according to the proposal with a visual display device 12 for displaying the information to be displayed. Reference may be made to all the remarks with respect to the weighing arrangement 1 according to the proposal.

The package-handling system 2 is equipped with a feed arrangement 13 for transporting respective packages 3 as a functional unit. The feed arrangement 13 is preferably a belt conveyor or a roller conveyor, where appropriate also at least one robotic arm, for moving the respective packages 3. The feed arrangement 13—here, the belt conveyor—exhibits here, and preferentially, at least one conveyor belt via which the respective packages 3 are transported along a direction of transport. The feed arrangement 13 has been set up here to supply the respective packages 3 to the weighing arrangement 1 and/or to take the respective packages 3 away from the weighing arrangement 1.

According to a preferred configuration, the weighing arrangement 1 in the package-handling system 2 has been set up for inspection weighing of the individual packages 3. In particular, a target weight value has been specified for the respective package 3, in which connection the control arrangement 9 and/or the evaluation unit 5 compare(s) the weight value of the package 3, ascertained via the weighing arrangement 1, with the target weight value. The package-handling system 2, in particular the weighing arrangement 1, may exhibit a sorting arrangement, not represented here, which has been set up for sorting out the packages 3 in a manner depending on the respective result of the inspection weighing. If a deviation is established in the course of the comparison with the target weight values—for instance, a difference between the ascertained weight value and the target weight value lying outside a specified tolerance—the package 3 is sorted out by means of the sorting arrangement. The sorting arrangement can preferentially remove the package 3 in question from the feed arrangement 13.

According to the configuration that is represented here, and that is preferred to this extent, the package-handling system 2 exhibits a labeling device, in particular a price-tagging device, for labeling the individual packages 3. The labeling device is equipped with the feed arrangement 13 already mentioned. Furthermore, a label-dispensing arrangement 14 has been provided for dispensing a label, in particular a label that is detachable from a strip of material 15. By “a label that is detachable from a strip of material 15”, in particular a label is meant that has been affixed in detachable manner by its adhesive surface to a carrier strip which constitutes the strip of material 15 and which may, for instance, consist of paper and/or synthetic material. It is similarly possible that the label is generated by separating a portion from a printable or printed strip of material 15, for instance by cutting and/or tearing the strip of material 15. Here, and according to a preferred configuration, labels configured as adhesive labels are employed that already exhibit an adhesive surface on the strip of material 15. Here, the strip of material 15 is conducted over a dispensing edge 16 by which the labels are detached. The use of adhesive-free labels that are only later provided with an adhesive surface or applied onto an adhesive surface on the respective package 3 is similarly also conceivable.

In addition, the labeling device—here, in a common housing with the label-dispensing arrangement 14—exhibits a label-application arrangement 17 for applying the dispensed label onto the respective package 3. As represented schematically in FIG. 1, the label-application arrangement 17 exhibits here, and preferentially, a punch 20, exhibiting a punch shaft 18 and a punch foot 19, for applying a label onto the upper side of the package 3. Via its punch foot 19, the punch 20 transfers the label from a transfer position onto the surface of the package 3 in one application movement.

The punch 20 has been configured here, and preferentially, as an oscillating punch which is both linearly traversable and tiltable. In particular, the punch 20 exhibits by way of punch foot 19 a suction foot, preferentially a suction-and-blowing foot, for aspirating the label and, in particular, also for blowing it off. The punch 20, configured here as an oscillating punch, executes here an application motion along the direction of transport when the label is being transferred, in order to enable a labeling of the package 3 being moved by means of the feed arrangement 13. With the label-application arrangement 17, the label can be applied in contacting manner—that is to say, mechanically—by pressing the label onto the package 3. Additionally or alternatively, it is conceivable that the label is applied in non-contacting manner, for instance in that a suction-and-blowing foot of the punch 20 blows the label off onto the package 3 by generating a puff of compressed air directed toward the package 3—that is to say, pneumatically. In principle, however, the punch 20 may also be a pure linear punch which then can only be moved linearly, where appropriate in several mutually orthogonal directions.

As represented in FIG. 1, here a label-aspirating arrangement 21 has been provided which transfers the detached labels from the dispensing edge 16 to the punch 20 at a transfer position. According to a further embodiment, not represented here, in principle it is also conceivable that the label is transferred directly from the transfer position onto the surface of the package 3, in particular by means of a puff of compressed air exerted onto the label by the label-aspirating arrangement 21, preferentially by a blowing head. In this case, a punch for transferring the label is then not necessary.

Furthermore, a printer arrangement 22 has been provided for printing the label that is detachable or detached from the strip of material 15, it being possible for printing of the label to occur, in principle, on the strip of material 15 and/or after the label has been detached from the strip of material 15 and before the label is applied onto the respective package 3. Here, and preferentially, a printer arrangement 22 has been provided which has been set up for thermal printing. The printer arrangement 22 is preferentially an integral part of the label-dispensing arrangement 14, and prints the labels before they are dispensed, in particular at the dispensing edge 16 of the label-dispensing arrangement 14.

The feed arrangement 13, the label-dispensing arrangement 14, the application arrangement 17 and the printer arrangement 22 each constitute functional units of the package-handling system 2—here, of the labeling device—which are preferably triggered by the control arrangement 9. In addition to the variant of a centralized control arrangement 9 that has been represented, several decentralized control arrangements—for instance, a decentralized control arrangement for each of the functional units—may have been provided, as already mentioned in the introduction.

The package-handling system 2 exhibits here, and preferentially, a user interface 23 for operation of the package-handling system 2 by the user. The user interface 23 serves for input of settings and also control commands for the package-handling system 2 relating to the handling of the packages 3—here, the labeling routine—and serves for output of information to the user relating to the handling. The user interface 23 communicates with the control arrangement 9 via a network 24. The network 24 may be a hard-wired and/or wireless network—for instance, a local network, a mobile-radio network and/or the Internet.

The user interface 23 has preferentially been configured as a mobile device and/or as a remote computer. With a remote computer, remote access to the control arrangement 9 is undertaken. By a “mobile device” in this connection, in particular a mobile phone, a personal digital assistant (PDA), a laptop represented by way of example in FIG. 1, a wearable computer and such like is understood.

According to a further teaching, to which independent significance is likewise attached, a method for operating a package-handling system 2 with a feed arrangement 13 for transporting respective packages 3, preferentially food packages, is, wherein the feed arrangement 13 is triggered by means of a control arrangement 9 of the package-handling system 2, wherein sensor data relating to the weight of the individual packages 3 are ascertained by means of a sensor unit 4 of a weighing arrangement 1, wherein system information that contains weighing parameters and also calibration information relating to the weighing parameters has been stored in an evaluation unit 5 of the weighing arrangement 1, wherein weight values for the individual packages 3 are determined from the sensor data by means of the evaluation unit 5 by reference to the weighing parameters, and wherein the weight values are communicated to the control arrangement 9 by means of the evaluation unit 5 via a data interface 8 of the weighing arrangement 1.

In this connection, it is essential that a display selection that defines at least some of the system information as information to be displayed has been stored in the evaluation unit 5, and that the display of the information to be displayed is brought about by means of the evaluation unit 5 via a visual display device 12 that is independent of the control arrangement 9.

The method is preferentially carried out by using the weighing arrangement 1 according to the proposal and/or by using the package-handling system 2 according to the proposal. Also to this extent, with respect to the method according to the proposal, reference may be made to all the remarks with respect to the weighing arrangement 1 according to the proposal and with respect to the package-handling system 2 according to the proposal.

1-16. (canceled)

17: A weighing arrangement for a package-handling system for handling individual packages, the weighing arrangement comprising:
a sensor unit configured to ascertain sensor data relating to the weight of the individual packages; and
an evaluation unit configured to store
system information that contains weighing parameters, and
calibration information relating to the weighing parameters;
wherein the evaluation unit is further configured to determine weight values for the individual packages from the sensor data by reference to the weighing parameters,
wherein the evaluation unit is further configured to communicate the weight values to a control arrangement of the package-handling system via a data interface of the weighing arrangement,
wherein the evaluation unit is further configured to store a display selection that defines at least some of the system information as displayable information, and
wherein the evaluation unit is further configured to bring about the display of the displayable information via a visual display device that is independent of the control arrangement.

18: The weighing arrangement as claimed in claim 17, wherein the display selection defines at least some of the weight values as the displayable information.

19: The weighing arrangement as claimed in claim 18, wherein the at least some weight values include one or more of net weight, gross weight, tare and weight range.

20: The weighing arrangement as claimed in claim 17, wherein at least one part of the display selection is permanently specified and/or is preselected in a manner depending on the package-handling system.

21: The weighing arrangement as claimed in claim 17, wherein at least one part of the display selection is permanently specified and/or is preselected depending on the location of the package-handling system.

22: The weighing arrangement as claimed in claim 21, wherein the preselection display selection that is dependent on the package handling system is permanently specified.

23: The weighing arrangement as claimed in claim 17, wherein a basic price value assigned to a product-type of the individual packages is specified to the evaluation unit, and wherein the control arrangement and/or the evaluation unit is configured to determine prices of the individual packages from the sensor data by reference to the basic price value.

24: The weighing arrangement as claimed in claim 23, wherein the display selection defines the price, the basic price value assigned to the product-type and/or the product-type as displayable information.

25: The weighing arrangement as claimed in claim 17, wherein the display selection defines a digital type-plate stored in the evaluation unit, which relates to at least one of minimally permissible weight, maximally permissible weight, weight-division values, weighing-instrument class, manufacturer, serial number and/or electrical operating-voltage values, as displayable information.

26: The weighing arrangement as claimed in claim 17, wherein the display selection defines the calibration information as displayable information.

27: The weighing arrangement as claimed in claim 26, wherein the calibration information is representative of a versioning of the evaluation unit, of a calibration period and/or of a deactivated state of the weighing system.

28: The weighing arrangement as claimed in claim 27, wherein the versioning is a software version.

29: The weighing arrangement as claimed in claim 17, wherein the evaluation unit is further configured to bring about the display of the displayable information in compliance with a specified period of time.

30: The weighing arrangement as claimed in claim 29, wherein the specified period of time is a minimum display duration and/or a maximum display duration, with respect to the time of the ascertainment of the sensor data, via the visual display device.

31: The weighing arrangement as claimed in claim 17, wherein the evaluation unit is further configured to undertake a check as to whether the display of the displayable information by the visual display device is capable of occurring.

32: The weighing arrangement as claimed in claim 31, wherein the check relates to the connection of the weighing arrangement to the visual display device, and/or to the operating state of the visual display device with the aid of a feedback from the visual display device.

33: The weighing arrangement as claimed in claim 31, wherein the evaluation unit is further configured to communicate the weight values to the control arrangement of the package-handling system only when, according to the check, the display of the displayable information by the visual display device is determined to be capable of occurring.

34: A package-handling system for handling individual packages having a feed arrangement for transporting respective packages, wherein the package-handling system includes a control arrangement for triggering the feed arrangement, and wherein the package-handling system includes a weighing arrangement as claimed in claim 17 and a visual display device for displaying the displayable information.

35: The package-handling system as claimed in claim 34, wherein the weighing arrangement in the package-handling system is configured for inspection weighing of the individual packages.

36: The package-handling system as claimed in claim 35, wherein the package-handling system includes a sorting arrangement configured for sorting out the packages in a manner depending on the respective results of the inspection weighing.

37: The package-handling system as claimed in claim 34, wherein the package-handling system includes a labeling device for labeling the individual packages, a label-dispensing arrangement for dispensing a label, a label-application arrangement for applying the dispensed label onto a respective one of the individual packages, and a printer arrangement for printing the label, and wherein the control arrangement is configured at least for triggering the printer arrangement.

38: The package-handling system as claimed in claim 37, wherein the labeling device is a price tagging device.

39: The package-handling system as claimed in claim 34, wherein the package-handling system includes a user interface for operation of the package-handling system by the user, and wherein the user interface is configured to communicate with the control arrangement via a network.

40: The package-handling system as claimed in claim 39, wherein the user interface is a mobile device and/or a remote computer.

41: A method for operating a package-handling system for handling individual packages having a feed arrangement for transporting respective packages, wherein the feed arrangement is triggered by means of a control arrangement of the package-handling system, wherein sensor data relating to the weight of the individual packages are ascertained by means of a sensor unit of a weighing arrangement, wherein system information that contains weighing parameters and also calibration information relating to the weighing parameters has been stored in an evaluation unit of the weighing arrangement, wherein weight values for the individual packages are determined from the sensor data by means of the evaluation unit by reference to the weighing parameters, wherein the weight values are communicated to the control arrangement by means of the evaluation unit via a data interface of the weighing arrangement, wherein a display selection that defines at least some of the system information as displayable information has been stored in the evaluation unit, and wherein the display of the displayable information is brought about by means of the evaluation unit via a visual display device that is independent of the control arrangement.
